(19) United States
(12) Patent Application Publication
(10) Pub. No.: US 2010/0243830 A1
(43) Pub. Date: Sep. 30, 2010

(54) Electronic Device

(75) Inventors: Yi-Ting Chen, Taipei (TW); Chin-Wei Chuang, Taipei (TW); Skay Lin, Taipei (TW); Li-Yen Wang, Taipei (TW); Kuan-Ting Chen, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASUSTEK COMPUTER INC., Taipei (TW)

(21) Appl. No.: 12/707,108

(22) Filed: Feb. 17, 2010

(30) Foreign Application Priority Data
Mar. 24, 2009 (TW) 98109500

(51) Int. Cl. F16M 11/04

(52) U.S. Cl. 248/176.3

(57) ABSTRACT

An electronic device includes a body and a stand. The body has a fastening structure. The stand is used to support the body and dispose the body at a plane. The stand has a curved surface, and a locating portion is disposed at the curved surface. The body and the plane are contacted with the curved surface at the same time. The body is located at a first position of the locating portion by the fastening structure. When a force is applied to the body, the locating portion is rotated to drive the stand to rotate. Thus, the fastening structure is located at a second position of the locating portion, and an angle between the body and the plane is adjusted.

### CROSS-REFERENCES TO RELATED APPLICATIONS

This non-provisional application claims priority under 35 U.S.C. §119(a) on Patent Application No. 98109500 filed in Taiwan, R.O.C. on Mar. 24, 2009, the entire contents of which are hereby incorporated by reference.

### BACKGROUND OF THE INVENTION

1. Field of the Invention

The invention relates to an electronic device and, more particularly, to an electronic device having a stand.

2. Description of the Related Art

In electronic devices, a product having a display function, such as a display is widely used. For example, the product may be used in a computer system to be an output interface between the computer system and a user. The user may see a result of executing a program via the display. The product also may be used in a TV field, and the display may have functions of a TV set via receiving television signals. Thus, the user may watch TV programs via the display.

The image quality of the display may vary with the laying positions or viewing angles of the user. For example, when the user is tall or the plane for locating the display is relatively lower than the user, the user may not enjoy the best image quality due to the unpreferred viewing angle, and the user even may fail to identify the content displayed by the display clearly.

Thus, generally, the display has a stand. The stand may support the display and make the display disposed on the plane stably, and it also may be adjusted by the user to achieve the best viewing angle. For example, when the display is disposed at a plane, the user may find that the angle of the display and the viewing line are not good, and he cannot watch the image shown in the display clearly. Thus, he may adjust the stand to further adjust the angle between the display and the plane. Then, the user may obtain a clear watching image.

However, when a stand in the conventional display is adjusted, the user has to apply a larger force to drive the stand of the display to change the angle of the display. When adjusting, the user cannot adjust the angle with a single hand, and he has to adjust the angle of the display with both hands. Thus, it's inconvenient for the user.

In addition, generally, the stand in the conventional display is designed to be solid, and a whole solid surface of the stand is disposed on the plane. Thus, the manufacturing cost of the stand is higher.

### BRIEF SUMMARY OF THE INVENTION

The invention provides an electronic device including a body and a stand. The body has a fastening structure. The stand is used to support the body to make the body disposed on the plane. The stand has a curved surface, and a locating portion is disposed at the curved surface. The body is located at a first position of the locating portion with the fastening structure. The body and the plane are contacted with the curved surface at the same time. When a force is applied to the body, the locating portion rotates to drive the stand to rotate therewith. Thus, the fastening structure is located at a second position of the locating portion, and the angle between the body and the plane is adjusted.

Via the electronic device disclosed in the invention, the user may adjust the angle between the body and the plane where the body is disposed easily and conveniently. In addition, since the stand of the electronic device is designed to be ring-shaped and hollow, the manufacturing cost is saved.

These and other features, aspects and advantages of the present invention will become better understood with regard to the following description, appended claims, and accompanying drawings.

### BRIEF DESCRIPTION OF THE DRAWINGS

FIG. 1A is a first three-dimensional diagram showing the electronic device in the first embodiment of the invention;

FIG. 1B is a second three-dimensional diagram showing the electronic device in the first embodiment of the invention;

FIG. 2A is a first schematic diagram showing the action of the electronic device;

FIG. 2B is a second schematic diagram showing the action of the electronic device;

FIG. 2C is a third schematic diagram showing the action of the electronic device;

FIG. 3A is a first sectional diagram showing the electronic device in a second embodiment of the invention;

FIG. 3B is a second sectional diagram showing the electronic device in a second embodiment of the invention; and

FIG. 4 is a sectional diagram showing the electronic device in a third embodiment of the invention.

### DETAILED DESCRIPTION OF THE EMBODIMENTS

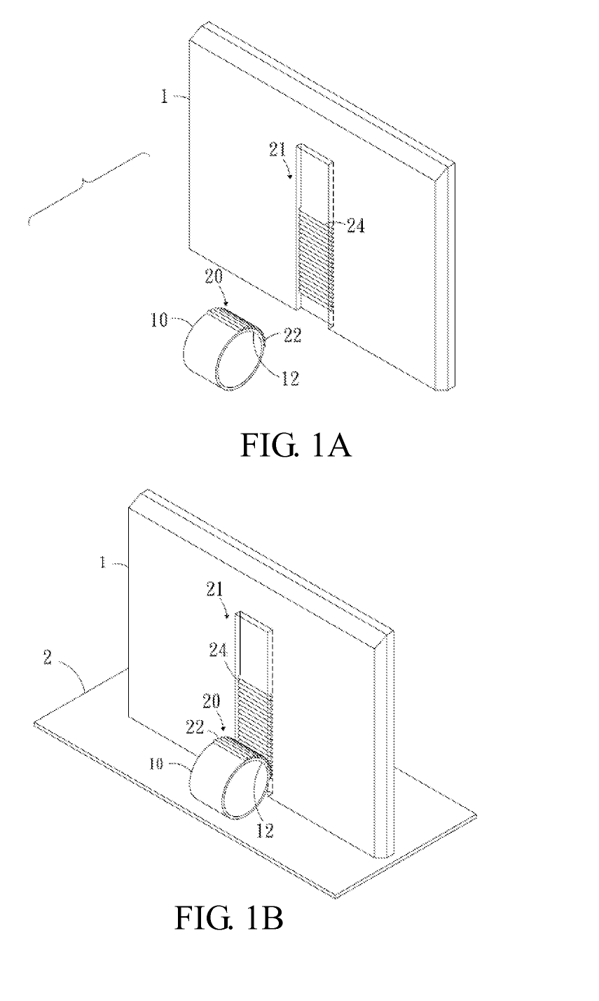

FIG. 1A and FIG. 1B are a first three-dimensional diagram and a second three-dimensional diagram showing an electronic device in the first embodiment. The electronic device in the invention includes a body 1 and a stand 10. The electronic device herein may be a display or a digital photo frame, and it is not limited thereto.

The body 1 has a fastening structure 21. The stand 10 is used to support the body 1 and make the body 1 disposed at the plane 2 stably. The stand 10 has a curved surface 12, and a locating portion 20 is disposed on the curved surface 12. The body 1 may be selectively located at a first position or a second position of the locating portion 20 by the fastening structure 21, which are illustrated hereinafter.

In an embodiment, the locating portion 20 is a zigzag structure. As shown in FIG. 1A or FIG. 1B, the locating portion 20 includes a first zigzag structure 22. Since the body 1 is connected to the locating portion 20 of the stand 10 via the fastening structure 21, the fastening structure 21 at the back of the body 1 includes a second zigzag structure 24 which may be engaged with the first zigzag structure 22. In the embodiment, the first zigzag structure 22 and the second zigzag structure 24 have a plurality of saw teeth, respectively, and each saw tooth or a number of saw teeth may form a first position or a second position in the locating portion 20. Thus, in the embodiment, the locating portion 20 has a plurality of positions which are formed by a plurality of saw teeth to locate the body 1.

When the user wants to adjust the angle of the body 1, he only needs to apply a force to the body 1 with a single hand to change the position of the body 1 from the first position to the second position of the locating portion 20. At that moment, the locating portion 20 may be rotated to drive the stand 10 to rotate, and the angle between the body 1 and the plane 2 is adjusted.

In the embodiment, the locating portion may be a zigzag structure. When the user applies a force to the body 1, the stand 10 is rotated therewith to adjust the angle between the body 1 and the plane 2. Since the body 1 and the stand 10 are connected to each other and rotate relative to each other via the second zigzag structure 24 and the first zigzag structure 22, when a force is applied to the body 1 to make the stand 10 rotate, just as rotating a gear, the user may apply less force than that applied in the conventional art. The user even may adjust the angle between the body 1 and the plane 2 with a single hand to improve the convenience in use.

In addition, considering the cost, the first zigzag structure 22 in the locating portion 20 may not be designed in the whole locating portion 20. Since the angle of the body 1 only has a specific adjusting range when the angle is adjusted, and that is, if the stand has a rotating path corresponding to the adjusting range of the angle of the body 1, the first zigzag structure 22 may be just disposed at the rotating path. As shown in FIG. 1A and FIG. 1B, the first zigzag structure 22 is only disposed at part area of the curved surface 12 of the stand 10, and the area where the first zigzag structure 22 is disposed is the rotating path allowing the angle of the body 1 to be adjusted. The body 1 and the plane 2 disposed the body 1 are contacted with the curved surface 12 at the same time.

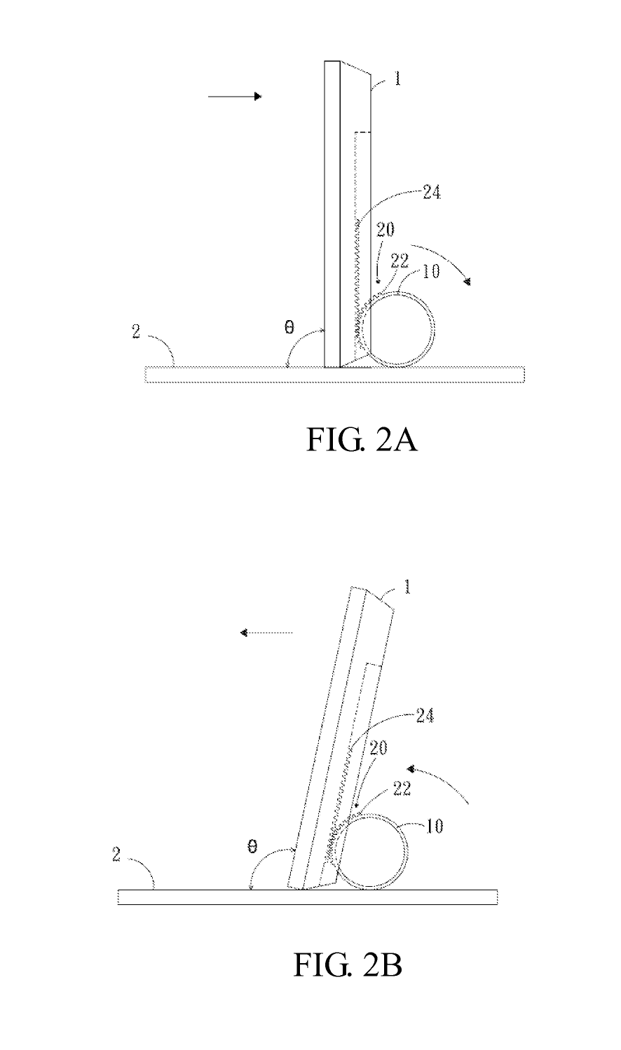

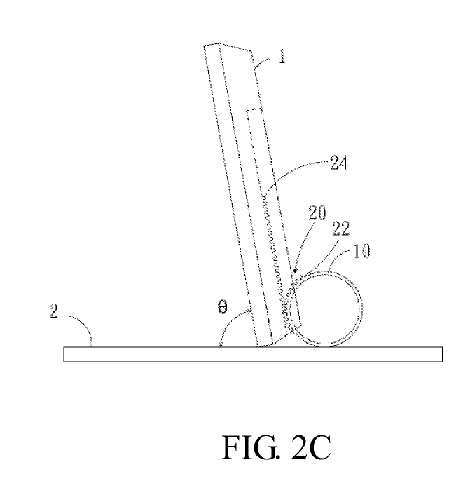

FIG. 2A to FIG. 2C are a first schematic diagram, a second schematic diagram and a third schematic diagram showing the actions of the electronic device. In FIG. 2A, when the stand 10 is erected, namely when the angle is not adjusted, the angle θ between the body 1 and the plane 2 is almost 90 degrees. As shown in FIG. 2B, when the user applies a force to the top of the body 1, and the direction of the force is a direction along which the force may make the body lean backward, the force may make the locating portion 20 rotate to drive the stand 10 to rotate therewith. At that moment, the stand 10 is rotated clockwise and upward, and the position of the body 1 located at the locating portion 20 is changed, and then the angle θ between the body 1 and the plane 2 is adjusted. As shown in FIG. 2B, the adjusted angle θ is greater than 90 degrees. Therefore, when the stand 10 is rotated clockwise, the angle θ of the body 1 may increase.

From another aspect, as shown in FIG. 2C, when the user applies a force to the body 1 again, the direction of the force is a direction along which the force may make the body 1 lean forward. The force also may make the locating portion 20 rotate and drive the stand 10 to rotate therewith. At that moment, the stand 10 rotates anticlockwise and downward, and the position of the body 1 at the locating portion 20 is changed. Thus, the angle θ between the body 1 and the plane 2 is adjusted. As shown in FIG. 2C, the adjusted angle θ is less than 90 degrees, and thus when the stand 10 is rotated anticlockwise, the angle θ of the body 1 decreases.

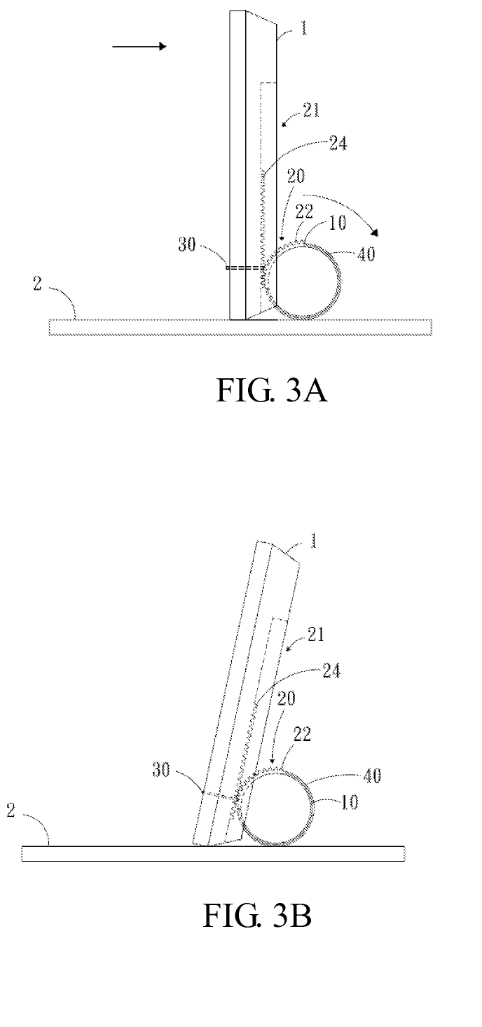

FIG. 3A and FIG. 3B are a first sectional diagram and a second sectional diagram showing the electronic device in a second embodiment of the invention, respectively. In the embodiment, the electronic device further includes a retainer 30 and a slip-proof part 40.

The retainer 30 is located between the fastening structure 21 and the locating portion 20 for controlling whether to allow the stand 10 to rotate. When the electronic device is adjusted to have a proper angle, the retainer 30 may retain the angle to prevent the stand 10 from being rotated. This may prevent unintended force from changing the adjusted angle.

As shown in FIG. 3B, when the retainer 30 is connected to the locating portion 20, the locating portion 20 and the stand 10 are not rotated when a force is applied to the body 1. In an embodiment, the retainer 30 is a tenon, and the locating portion 20 includes the zigzag structure 22 which is fastened with the tenon via a mechanism. Thus, the stand 10 cannot be rotated. As shown in FIG. 3A, when the user needs to adjust the angle of the body 1 again, the user only needs to detach the retainer 30 from the locating portion 20, and thus the locating portion 20 and the stand 10 may be rotated under the force applied on the body 1.

In addition, to make the body disposed on the plane 2 stably via the stand 10, a slip-proof part 40 may be disposed at the bottom of the stand 10. The slip-proof part 40 may be made of a material having high friction coefficient such as the rubber.

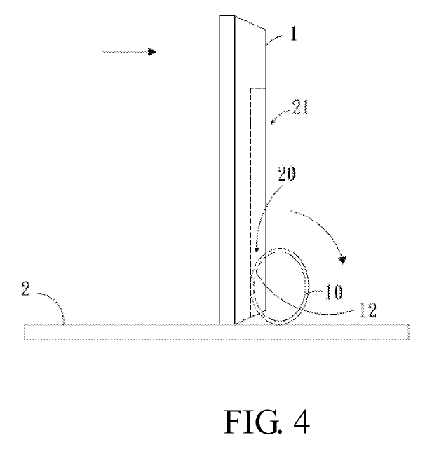

As shown in the figures above, the stand 10 is ring-shaped and hollow. Due to the ring-shaped and hollow design, the manufacture cost is reduced compared with the conventional solid stand. In addition, although the stands 10 are all round in the figures above, the shape of the stand 10 is not limited to be round. FIG. 4 is a sectional diagram showing the electronic device in a third embodiment of the invention. In the embodiment, the stand 10 also may be oval. In actual application, the stand 10 may have a curved surface 12 to dispose the locating portion 20, and it may be rotated clockwise and anticlockwise in a certain range. Thus, the shape of the stand 10 may be any polygon having the curved surface 12.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An electronic device comprising:
a body having a fastening structure; and
a stand for supporting the body to dispose the body at a plane, wherein the stand has a curved surface, and the curved surface has a locating portion;
wherein the body is located at a first position of the locating portion via the fastening structure, and when a force is applied to the body, the locating portion is rotated to drive the stand to rotate to make the fastening structure located at a second position of the locating portion to adjust an angle between the plane and the body.

2. The electronic device according to claim 1, wherein the locating portion comprises a first zigzag structure, and the fastening structure comprises a second zigzag structure engaging with the first zigzag structure.

3. The electronic device according to claim 2, wherein the range of the angle in which the body is capable of being adjusted is a rotating path, and the first zigzag structure is disposed at the rotating path.

4. The electronic device according to claim 1, further comprising:
a retainer located between the fastening structure and the locating portion, wherein when the retainer is connected to the locating portion, the fastening structure and the locating portion are not rotated when the force is applied to the body, and when the retainer is detached from the locating portion, the fastening structure and the locating portion are rotated when the force is applied to the body.

5. The electronic device according to claim 4, wherein the retainer is a tenon.

6. The electronic device according to claim 1, further comprising:
a slip-proof part disposed at the bottom of the stand.

7. The electronic device according to claim 1, wherein the stand is a ring-shaped hollow element.

8. The electronic device according to claim 7, wherein the stand is round or oval.

9. The electronic device according to claim 7, wherein the stand is a polygon having the curved surface.

10. The electronic device according to claim 1, wherein the body and the plane are contacted with the curved surface at the same time.
